(19) United States
(12) Patent Application Publication
(10) Pub. No.: US 2018/0270785 A1
(43) Pub. Date: Sep. 20, 2018

(54) Apparatus for Notification of Parcel Delivery

(71) Applicants: David R. Hall, Provo, UT (US); Mark Hall, Springville, UT (US)

(72) Inventors: David R. Hall, Provo, UT (US); Mark Hall, Springville, UT (US)

(21) Appl. No.: 15/458,529

(22) Filed: Mar. 14, 2017

(51) Int. Cl. H04W 68/00; H04W 4/14; G10L 13/04; G10L 15/26; G06K 9/20; G06Q 10/08; B64C 39/02

(52) U.S. Cl. CPC H04W 68/005; H04W 4/14; G10L 13/043; G06F 17/289; G06K 9/2027; G06Q 10/0833; B64C 39/024; G10L 15/265

(57) ABSTRACT

A parcel delivery verification apparatus includes a processor communicatively connected to a notice actuator button, an optical sensor, an optical illumination device, an audio input device, an audio output device, and a non-transitory storage medium. The non-transitory storage medium stores a number of modules. The modules include an alert module, a send module, a receive module, and an output module. The alert module activates the apparatus when input is received from an input sensor. The send module sends, to a user operator, a text message. The text message notifies the user operator of an arriving parcel. The receive module receives a received text message from the user operator. The output module outputs a message based on the text message from the user operator.

### TECHNICAL FIELD

The disclosure relates generally to the field of parcel delivery. Specifically, the disclosure relates to the delivery of a parcel to a destination.

### BACKGROUND

The Internet and other technological changes have brought about sweeping changes in communications and commerce. While overnight parcel delivery services have become commonplace in recent years (for example, Federal Express, United Parcel Service, and Airborne), these services have great difficulty delivering to individual homes. The occupant of the home is often not there (being at work, for example), and thus a carrier may have to visit the home two or more times to effect delivery. Often, a parcel delivery person will leave a parcel unattended. An unattended parcel may be stolen, causing inconvenience for the occupant and cost for the retailer. A sophisticated thief may place a fraudulent order using a stolen credit card. The thief may have the parcel delivered to a house where the resident is often not present and then steals the parcel when it is left unattended.

Some retailers have placed a number of containers at a predetermined location, such as a grocery store or post office. The parcel recipient receives a message that the parcel has been delivered to the predetermined location. The parcel recipient then retrieves the parcel from the predetermined location. This solution allows for the parcel to be kept in a secure location at all times. However, this solution also has the parcel recipient travel to the predetermined location to retrieve a parcel, similar to a post office box. This may delay the receipt of the parcel. The travel of the parcel recipient may cause environmental problems, such as pollution from a vehicle or traffic congestion. A successful retailer may be challenged by having all containers at the predetermined location be in use, complicating the delivery of parcels.

Security of parcels and parcel theft has become a challenge for both retailers and consumers. Parcel theft harms many members of society and increases the cost of merchandise. Further, individuals who speak different languages may be unable to communicate in a common language. Responding to a parcel delivery person may make an individual who speaks a different language vulnerable to an attack.

### BRIEF SUMMARY

A parcel delivery verification apparatus includes a processor communicatively connected to a notice actuator button, an optical sensor, an optical illuminator, an audio output device, an audio input sensor, and a non-transitory storage medium. The notice actuator button initiates a notice that the parcel delivery verification apparatus is monitoring for the delivery of a parcel. The optical sensor reads visual input from the optical sensor for the apparatus. The optical illuminator illuminates an area to enhance an image created by the optical sensor. The audio output device provides audio output at the apparatus location. The audio input sensor senses audio input. A non-transitory storage medium stores a number of modules. Each module, when executed, causes the apparatus to perform a particular function. The non-transitory storage medium may include an alert module, a drone sensing module, an image module, a greeting module, an output module, a text-to-voice module, a language translation module, a send module, a receive module, and an output module. The alert module activates when input is received from an input sensor. The send module sends, to a user operator, a text message. The text message notifies the user operator of the arrival of a parcel. The receive module receives a received text message from the user operator. The output module outputs a message based on the text message from the user.

A method for verifying the delivery of a parcel using a parcel delivery notification apparatus is described. The method includes activating a parcel delivery apparatus when input is received from an input sensor, sending to a user operator, a text message, the text message notifying of the arrival of a parcel, receiving a received text message from the user operator; and outputting a message based on the text message from the user.

### BRIEF DESCRIPTION OF THE DRAWINGS

A more particular description of the invention briefly described above is made below by reference to specific examples. Several examples are depicted in drawings included with this application. An example is presented to illustrate, but not restrict, the invention.

FIG. 1 illustrates a diagram of a use for an apparatus for notifying of a delivered parcel.

FIG. 2 illustrates a diagram of an apparatus for notifying of a delivered parcel.

FIG. 3 illustrates an apparatus for notifying of a delivered parcel in communication with a smart device.

FIG. 4 illustrates a device for communication with an apparatus for notifying of a delivered parcel.

FIG. 5 illustrates a method for notifying of a delivered parcel.

FIG. 6 illustrates a method for notifying of a delivered parcel.

### DETAILED DESCRIPTION

A detailed description of the claimed invention is provided below by example, with reference to examples in the appended figures. Those of skill in the art will recognize that the components and steps of the invention as described by example in the figures below could be arranged and designed in a wide variety of different configurations, without departing from the substance of the claimed invention. Thus, the detailed description of the examples in the figures is merely representative of the invention, and is not intended to limit the scope of the invention as claimed.

For purposes of this disclosure, the modules refer to a combination of hardware and program instructions to perform a designated function. Each of the modules may include a processor and memory. The program instructions are stored in the memory, and cause the processor to execute the designated function of the modules. Additionally, a smartphone app and a corresponding computer system for the smartphone app may be used to interact with the parcel delivery notification apparatus.

A purpose of the claimed methods and computer program product is to facilitate the notification that a parcel has been delivered. In one example, the parcel recipient may be a retail consumer having a parcel delivered to the recipient's dwelling. In a different example, a business may have a number of parcels delivered to a business location. A parcel may be a container that contains a number of additional items or parcels.

The parcel delivery notification apparatus may use wireless networking protocols. The wireless networking protocols may include any protocol used with Internet of Things (“IoT”) including but not limited to Bluetooth, ZigBee, Ethernet, WirelessHART, DigiMesh, ISA100.11a, IEEE 802.15.4, NFC, ANT, Eddystone, EnOcean, Wi-Fi, and WiMAX. The wireless communication protocol allows the parcel delivery apparatus to communicate with a computing device associated with the person receiving the parcel, or with a central server that communicates a combination of the parcel recipient.

The method for notifying of a delivered parcel may be implemented by an apparatus that maintains a two-way connection between the apparatus and a control server. In one example a parcel delivery notification apparatus communicates with a control server to receive messages to relay to a parcel delivery person. In another example, the control server may generate responses to the parcel delivery notification apparatus.

With a control server connected to an apparatus that implements a method, a two-way connection may be maintained. The control server and the Wi-Fi router may communicate over a hardwired connection such as Ethernet, coaxial cable, or fiber optic cable. The device data server and the Wi-Fi router may communicate using a wireless protocol, such as 802.1(g), 802.1(n), or another wireless protocol.

For purposes of this disclosure as used in the present specification and in the appended claims the term “parcel” refers to a thing that is wrapped, packaged, or prepared for shipment. A parcel may be used to ship goods in a retail transaction, or may be used to privately distribute a gift or goods.

As used in the present specification and in the appended claims, the term door means a particular device, system, or apparatus used to prevent passage past the device, system, or apparatus.

As used in the present specification and in the appended claims, the term “a number” refers to one or more of an item, zero not being a number, but rather, the absence of a number.

As used in the present specification and in the appended claims, the term communication refers to the imparting or exchange of information.

As described above, a parcel recipient may be unwilling to see a parcel delivery person. The unwillingness may be caused by an anticipated language barrier. The unwillingness may be caused by a desire for anonymity. Additionally, a parcel recipient may desire to respond to a parcel delivery person from a remote location. The parcel recipient may have a myriad of reasons for not personally contacting the parcel delivery person. In one example, the parcel recipient is in a remote location and has limited connectivity. Such a connection may have limited bandwidth for communication. The parcel delivery notification apparatus may serve different roles for different users.

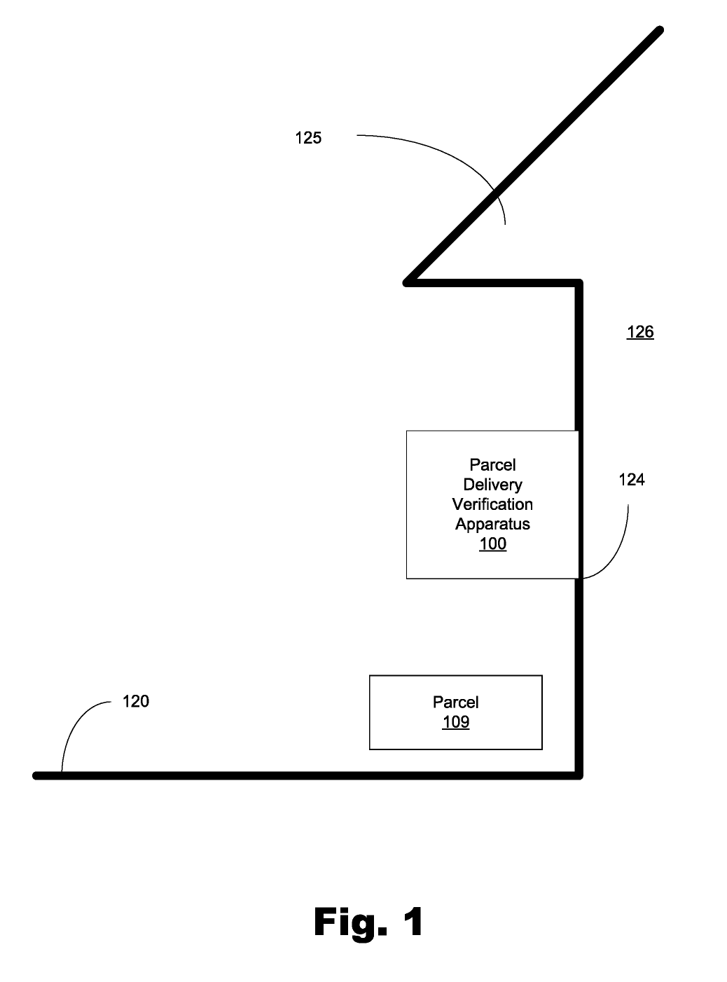

Referring now to the figures, FIG. 1 illustrates a diagram of a use for an apparatus for notifying a parcel recipient a parcel has been delivered. As illustrated, a parcel delivery verification apparatus (100) is affixed to a building (126) to verify the delivery of a parcel (109).

An overall example will be given according to FIG. 1. A parcel delivery verification apparatus (100) is affixed to a building (126) near a door (124). The parcel (109) is placed on the ground (120) near the building (126) and the parcel delivery verification apparatus (100). A parcel delivery person delivers a parcel (100) to the building (126). As the parcel delivery person approaches the building (126) with the parcel (109), the parcel delivery verification apparatus (100) may activate and initiate parcel delivery verification. The parcel delivery person may press a notice actuator button. The notice actuator button may appear to the parcel delivery person to be a common doorbell. An audio output device, such as a speaker, may greet the parcel delivery person and prompt a verbal response from the parcel delivery person. The verbal response is received using an audio input sensor. The verbal response is converted into a text message and sent to a building occupant or resident. The building occupant or resident may respond to the text message. The responses may be received by the parcel delivery verification apparatus (100). The parcel delivery verification apparatus (100) may convert the received text message to create audio output that sounds like a human voice. In this example, the building occupant or resident is able to communicate with the parcel delivery person without disclosing details as to the identity of the building occupant or resident.

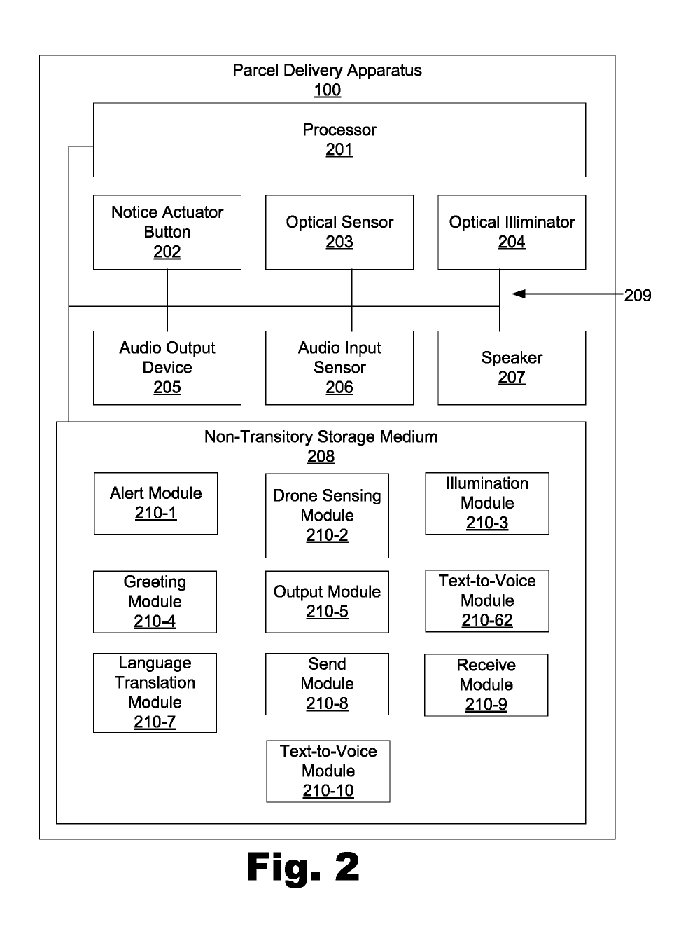

FIG. 2 illustrates a parcel delivery verification apparatus (100) for verifying the delivery of a parcel, according to one example of the principles described herein. The parcel delivery verification apparatus (100) includes a processor (201), a notice actuator button (202), an optical sensor (203), an optical illuminator (204), an audio output device (205), an audio input sensor (206), and a non-transitory storage medium (208). The processor (201), notice actuator button (202), optical sensor (203), optical illuminator (204), audio output device (205), audio input sensor (206), and non-transitory storage medium (208) are communicatively connected using a communication bus (207). The non-transitory storage medium (208) includes a number of modules. Each module may include computer program code, hardware, or combinations thereof to cause the parcel delivery verification apparatus (100) to perform a particular task.

The processor (201) executes computer program code. The computer program code causes the parcel delivery verification apparatus (100) to perform a particular task.

The notice actuator button (202) is an interface to the parcel delivery verification apparatus (100). The notice actuator button (202) may be a physical button that is pressed to alert a building occupant or resident that someone or something is attempting to contact an occupant of the building. The notice actuator button (202) may be implemented using a computer touchscreen to simulate a physical button. The notice actuator button (202) may include additional features, such as illumination, to enhance the experience of someone pressing the notice actuator button (202).

The optical sensor (203) may be an interface to receive optical input for the parcel delivery verification apparatus (100). An example of an optical sensor (203) is a digital camera. Another example of an optical sensor is an infrared camera. The optical sensor may receive optical input and may digitizes the optical input for processing by the processor (201) for the parcel delivery verification apparatus (100).

The optical illuminator (204) may provide illumination for the optical sensor (203) to enhance the quality of an image created by the optical sensor (203). In one example, the optical illuminator (204) may be a light that provides illumination for a digital camera. The optical illuminator (204) may provide other illumination for the optical sensor (203).

The audio output device (205) may provide audio output at the location of the parcel delivery verification apparatus (100). The audio output device (205) may be a single speaker or a number of speakers. The audio output device (205) may be mechanically integrated as part of the parcel delivery verification apparatus (100). The audio output device (205) may be communicatively connected to the parcel delivery verification apparatus using a wireless technology such as Bluetooth. The audio output device (205) may be capable of producing audio sounds or simulating human speech. The audio output device (205) may also be capable of producing sounds outside the hearing range of humans. Audio sounds outside the hearing range of humans may be used to communicate with parcel delivery devices.

The audio input sensor (206) may receive audio input for the parcel delivery verification apparatus (100). The audio input sensor may be a microphone or other audio input device.

The communication bus (207) may allow the different devices and sensors and illuminators to communicate with the processor (201).

The non-transitory storage medium (208) may include a number of modules. In this example, the non-transitory storage medium (208) includes an alert module (210-1), a drone sensing module (210-2), an image module (210-3), a greeting module (210-4), and output module (210-4), a voice-to-text module (210-5), a language translation module (210-6), a send module (210-7), a receive module (210-8), and a text-to-voice module (210-9).

The alert module (210-1) may activate the parcel delivery verification apparatus from a low-power state. The low-power state may allow the parcel delivery verification apparatus (100) to conserve batteries or use less power. The low-power state may also prevent the sending of spurious messages to a user. The alert module (210-1) may be activated by input from the audio input sensor (206) or the optical input sensor (203). The alert module (210-1) may wake up the parcel delivery verification apparatus (100) from a sleep state.

The drone sensing module (210-2) may detect the presence of a parcel delivery drone. A drone is a mechanical device that may be used to deliver parcels. A drone may include a number of blades such as those used on a helicopter and may suspend the parcel until it is delivered.

The image module (210-3) may create an image using the optical sensor (210-3) and the optical illuminator (210-4). An image may be processed on the parcel delivery verification apparatus (100) to determine when a parcel has been delivered. A number of images may be compared to identify changes visible to the parcel delivery verification apparatus (100). The image module (210-3) may store a number of images on a non-transitory storage medium (208) to identify events or people related to the delivery of the parcel (FIG. 1, 109).

The greeting module (210-4) may initiate a greeting to a parcel delivery person or a parcel delivery drone upon detecting the presence of either a parcel delivery person or a parcel delivery drone. The greeting module (210-4) may provide a human voice for a parcel delivery person. The parcel delivery person may believe that he or she is being watched. When a parcel delivery person believes that he or she is being watched, he or she may treat the parcel better. The greeting module (210-4) may provide an indication to a parcel delivery drone that the parcel delivery drone has arrived at the proper location to deliver the parcel.

The voice-to-text module (210-5) may receive audio input from the audio input sensor (206). The audio input may include the analog or digital representations of words spoken by a person. The voice-to-text module (210-5) may convert the audio from the audio format to a text-based format. For example, a parcel delivery person may state that a parcel is being delivered for a person. The words that the parcel delivery person speaks may then be converted into a text-based representation.

The language translation module (210-6) performs an automated translation of text produced by the voice-to-text module (210-5). The automated language translation module (210-6) may detect the language spoken. The language translation module (210-6) serves to bridge the gap between speakers of different languages. A text based representation permits a mechanical device that may include a software package to translate from a first language to a second language.

The send module (210-7) may send a text-based representation of the message received from a parcel delivery person or a parcel delivery drone. The send module (210-7) may send a text-based message produced by the voice-to-text module (210-5). The send module (210-7) may send a text-based message based on the output of the language translation module (210-6). The text-based message may be formatted in the Short Message Service protocol, Multimedia Messaging Service protocol, application-to-person messaging protocol or other text-message protocol adaptable for sending short messages via the Internet. In other embodiments, a text-based message may be sent in a single packet in which the number of characters in the packet is in the range of 1 character to 30 characters, 1 character to 70 characters, 1 character to 100 characters, 1 character to 140 characters, 1 character to 1000 characters, 1 character to 10,000 characters, or 2 characters to 90 characters.

The receive module (210-8) receives a text-based message from a user or operator. The text-based message may be in response to the text-based message sent by the send module (210-7). The receive module (210-8) allows a user, resident, or building occupant to interact with the parcel delivery verification apparatus (100) without being physically present at the apparatus. The receive module (210-8) may invoke the language translation module (210-6) to translate the received message from a second language back to a first language spoken by the parcel delivery person.

The text-to-voice module (210-9) may cause the parcel delivery verification apparatus (100) to convert the received text message into audio output. A voice module may be used to provide for a synthesized voice chosen by the user, resident, or building occupant. The synthesized voice may create the illusion that the user, resident, or building occupant has a different persona than the actual persona of the user, resident, or building occupant. In one example, a female resident may use a synthesized male voice. In another example, a resident that speaks one language may be able to hide the language they speak.

The output module (210-10) may present the output of the text-to-voice module (210-9), the received text-based message, or other output data to the parcel delivery person or parcel delivery apparatus. The output module (210-10) may use the audio output device (205) to communicate with a parcel delivery person. The output module (210-10) may use the optical illuminator (204) to interact with a parcel delivery person.

An overall example according to FIG. 2 will now be given. A parcel delivery person approaches a door (FIG. 1, 124) of a building (FIG. 1, 126) with a parcel (FIG. 1, 109). The parcel delivery person pushes the notice actuator button (202) which invokes the alert module (210-1). The alert module (210-1) wakes up the parcel delivery verification apparatus (100).

The image module (210-3) uses the optical illuminator (204) and optical sensor (203) to take a picture of the parcel delivery person with the parcel (FIG. 1, 109). The image module (210-3) analyzes the image to verify that the parcel delivery person is carrying a parcel (FIG. 1, 109).

The greeting module (210-4) invokes the output module (210-10) to present a predetermined greeting to the parcel delivery person. The greeting module (210-4) may use the image illuminator (204) to convey information to the parcel delivery person. In this example, the image illuminator (204) is used to indicate a preferred location for the parcel to be placed.

The voice-to-text module (210-5) receives audio input using the audio input sensor (205) from the parcel delivery person. The parcel delivery person, in this example, indicates the name of a resident for whom the parcel is intended. The voice-to-text module (210-5) may convert the voice input into a text-based message.

The language translation module (210-6) converts the text-based message from the language spoken by the parcel delivery person to the language of the resident of the home. The language translation module detects which language is spoken by the parcel delivery person. The language translation module (210-6) creates a translated text-based message. The translated text-based message may then be processed further by the parcel delivery apparatus. The translated message may be sent to the home resident.

The send module (210-7) sends a text-based message to an operator, user, resident, or building occupant, indicating that a parcel has been delivered. The message may include the voice to text transcription of a message from the parcel delivery person. The message may include the output of the language translation module (210-6). In this example, the message includes the output of the language translation module (210-6), as well as a picture of the parcel delivery person.

The receive module (210-8) may receive a response from the operator, user, resident, or building occupant. The response text message that have been received provides information to convey to the parcel delivery person.

The text-to-voice module (210-9) converts the received text message to an audio file. The text-to-voice module (210-9) invokes the language translation module (210-6) to provide a response in the language spoken by the parcel delivery person.

The output module (210-10) outputs the translated message for the parcel delivery person using the audio output device (205).

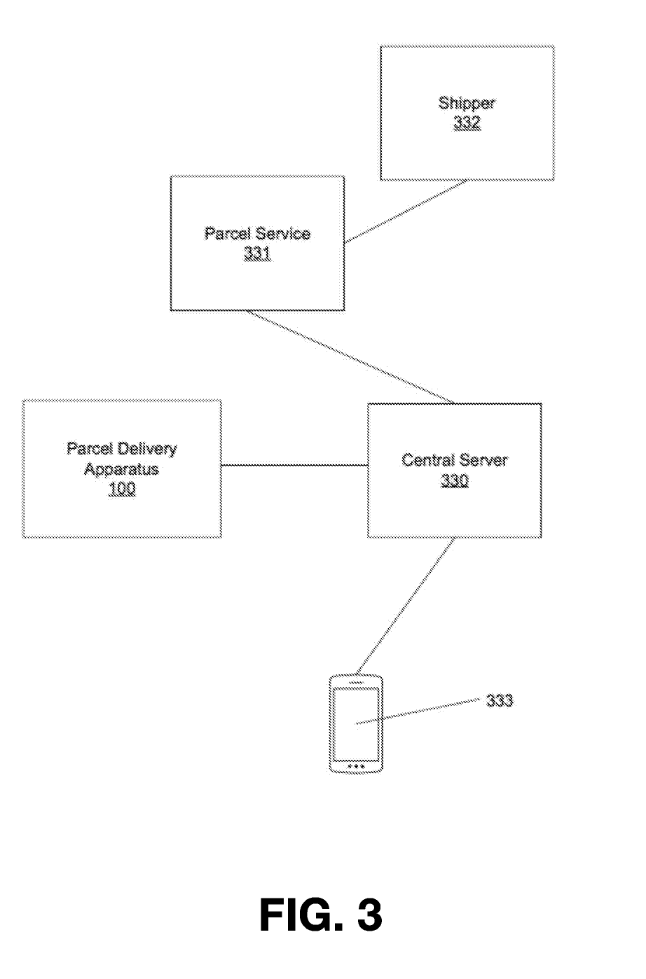

FIG. 3 illustrates an apparatus for verifying the delivery of a parcel using a parcel delivery verification apparatus (100). The parcel delivery verification apparatus receives audio input from a parcel delivery person and prepares a text-based file to send to a user of the parcel delivery verification apparatus (100), as described in FIG. 2.

The text-based message may be sent to a central server (330). The central server may log information related to the text-based message, and may provide a security portal for an application on a device associated with the user.

A user may be in possession of a smart device (333) such as a smart phone, tablet, or portable computing device. The smart device (333) may be capable of receiving text-based messages. The messages may be received as a text message, or they may be received as part of an application interface.

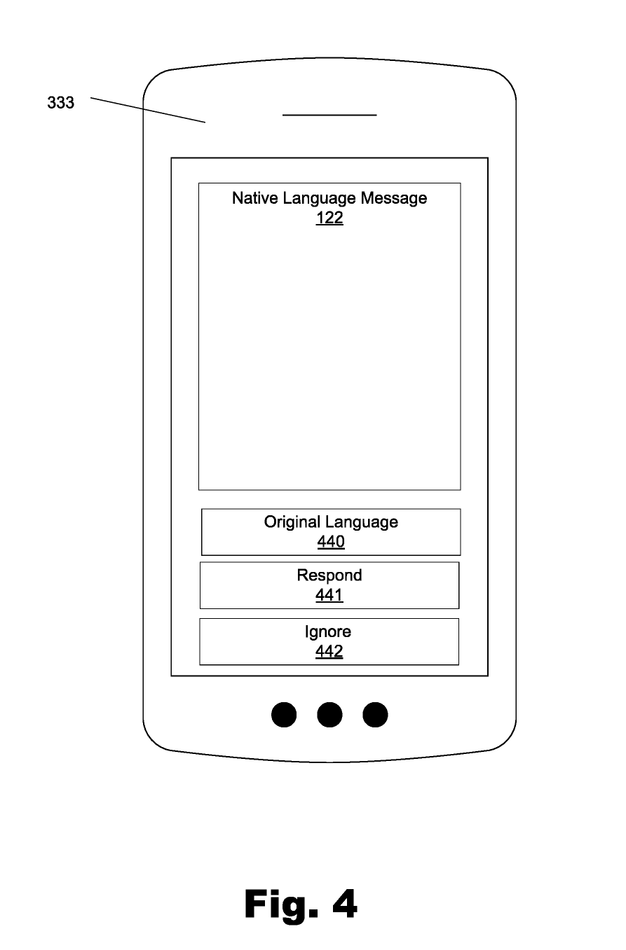

FIG. 4 illustrates a smart device (333) for communicating with a parcel delivery verification apparatus. In this example, the smart device (333) is a smart phone capable of displaying multiple interfaces at once. As shown in this example, the smart device (333) displays a native-language message (433), an option for an original language (440) message, an option to respond (441), and an option to ignore (442).

The native-language message (422) represents a text-based message in the native language of the user of the smart device (333). The native-language message (422) represents a message in a language that is easiest for the user of the smart device (333) to understand.

The original language (440) option allows the user of the smart device (333) to change the language of the message displayed to the original language spoken by the parcel delivery person. The original language (440) option allows the user of the smart device (333) to verify the translation or clarify mistranslations of the language translation module (FIG. 2, 210-6).

The respond (441) option allows the user of the smart device (333) to respond in text format to the message received from the parcel delivery person. The user of the smart device may respond in either the user's native language or in the same language as the parcel delivery person.

The ignore (442) option allows the user of the smart device (333) to cease interacting with this individual parcel delivery person. The ignore (442) option will cause the messages from the parcel delivery verification apparatus (100) to be suppressed for a period of time, or until a predetermined event occurs.

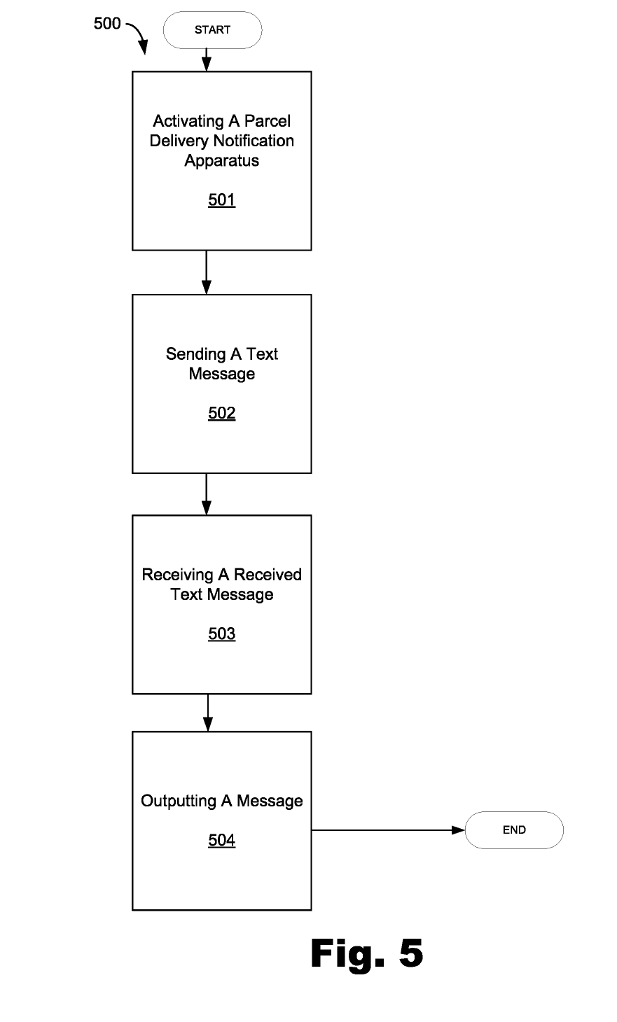

FIG. 5 illustrates a method (500) for verifying the delivery of a parcel using a parcel delivery verification apparatus (FIG. 1, 100), according to one example of the principles described herein. The method (500) includes activating (501) the parcel delivery verification apparatus (FIG. 1, 100) when input is received from an input sensor. The method (500) includes sending (502) to a user operator, a text message, the text message notifying the user operator of the arrival of a parcel. The method (500) includes receiving (503) from the operator user, a received text message. The method (500) includes outputting (504), based on the text message from the user operator, information from the parcel delivery verification apparatus (100).

The method (500) includes activating (501) the parcel delivery verification apparatus (FIG. 1, 100) when input is received from an input sensor. The activating (501) may cause the parcel delivery verification apparatus to wake from a low power state. An input sensor may be an audio input sensor (FIG. 2, 206), an optical sensor, (FIG. 2, 203), or a notice actuator button (202). Other input sensors, such as motion detectors, may be used.

The method (500) includes sending (502) to a user operator, a text message, the text message notifying the user operator of the arrival of a parcel. The text message may be a voice-to-text transcription of a statement made by a parcel delivery person. The text message may be a translation of the voice-to-text transcription of a statement made by a parcel delivery person.

The method (500) includes receiving (503) a received text message from the user operator. The received text message includes a response from the user operator to the parcel delivery person.

The method (500) includes outputting (504), based on the text message from the user operator, a message on the parcel delivery verification apparatus (FIG. 1, 100). The message outputted may communicate information to a parcel delivery person.

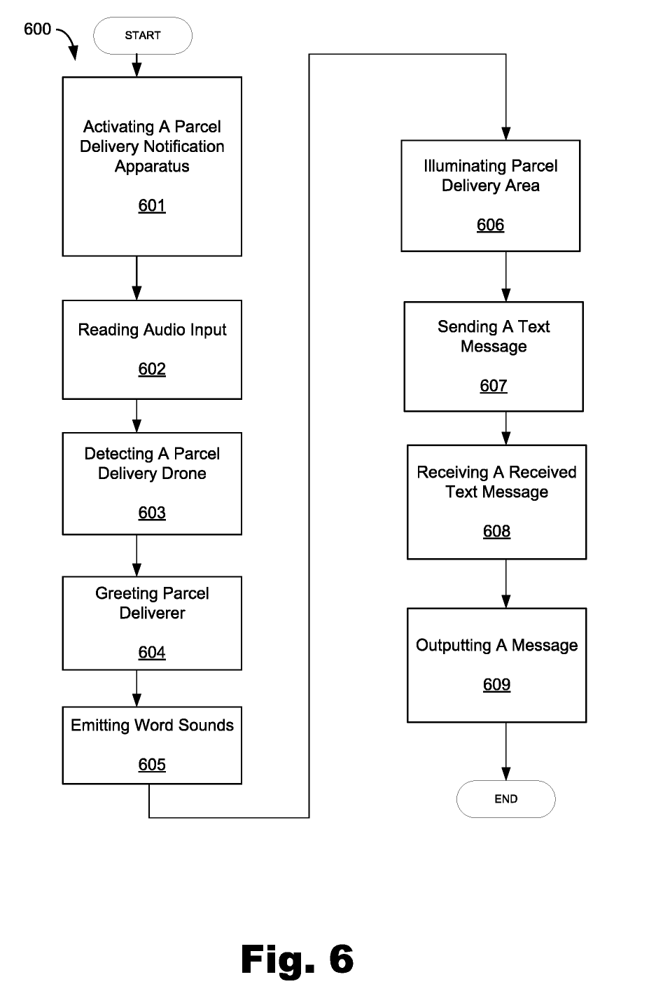

FIG. 6 illustrates a method (600) for verifying the delivery of a parcel using a parcel delivery verification apparatus (FIG. 1, 100), according to one example of the principles described herein. The method (600) includes activating (601) a parcel delivery verification apparatus when input is received from an input sensor. The method (600) includes reading (602), from an audio input sensor, audio input. Although in some embodiments, the method (600) includes both steps (603) and (604), in the preferred embodiments, the method (600) includes either step (603) or step (604). When the method (600) includes step (603), then the method (600) includes detecting (603) a parcel delivery autonomous vehicle, such as a drone, using an audio input sensor and an optical input sensor. When the method (600) includes step (604), then the method includes greeting (604) a parcel delivery person. The method (600) may include emitting (605) word sounds to communicate with the parcel deliverer. The method (600) may include illuminating (606) a parcel delivery area. The method (600) may include sending (607) a text message to a user operator. The method (600) may include receiving (608) a received text message from a user operator. The method (600) may include outputting (609) a message to a parcel deliverer.

As described above, the method may include activating (601) a parcel delivery verification apparatus when input is received from an input sensor.

The method (600) may include reading (602), from an audio input sensor, audio input. The audio input may represent a message from a parcel deliverer to a user operator. The audio input may be a message in any of a number of spoken languages. Spoken languages include languages such as English, Spanish, French, German, Mandarin, Cantonese or similar methods of communication. Alternatively, video input of a sign language, such as American sign language, may be used as an alternative to audio input. Interpreted video input may be used to create audio input. For example, the method may include using an interpretation module to convert a word or group of words, which are signed in American Sign Language and captured by a video cam, to an audio, translated version; this would allow an optical sensor, such as a camera, to function as an audio input device.

The method (600) may include detecting (603) a parcel delivery drone. The parcel delivery drone may be detected using audio input, optical input, radio input, or combination thereof. For example, the method (600) may detect the sound of a drone motor and verify that sound with an image of a drone and confirm the identity of the drone using radio frequency input.

The method (600) may include greeting (604) the parcel deliverer. The greeting may use an audio output device, an optical illumination device, or a radio transmitter. The greeting (604) may indicate to the parcel deliverer that the parcel deliverer is in the correct location to deliver the parcel. The greeting (604) may provide instructions to the parcel deliverer on the delivery of the parcel at this location.

The method (600) may include emitting (605) word sounds. The emission of word sounds may provide instructions to the parcel deliverer. The step of greeting (604) the parcel deliverer may include emitting word sounds.

The method (600) may include illuminating (606) a parcel delivery location. Illuminating (606) the parcel delivery location may inform the parcel deliverer of a preferred location to leave the parcel. Illuminating (606) may include signing a light on the porch or delivery area of a house or building for which a package is to be delivered. Illuminating (606) may include illuminating a parcel which is in view of an optical sensor.

As described above, the method (600) may include sending a text message. As described above, the method (600) includes receiving (608) a received text message.

The method (600) includes outputting (609) a message to a parcel deliverer. The message outputted may use a combination of an audio output device, an optical illuminator, a radio transmitter, or a visual display.

The foregoing descriptions of embodiments have been presented only for purposes of illustration and description. They are not intended to be exhaustive or to limit the embodiments to the forms disclosed. Accordingly, many modifications and variations will be apparent to practitioners skilled in the art. Additionally, the above disclosure is not intended to limit the embodiments. The scope of the embodiments is defined by the appended claims.

1. A parcel delivery verification apparatus, the apparatus comprising:
a processor;
a notice actuator button communicatively connected to the processor, the notice actuator button initiating a notice that monitoring is to begin;
an optical sensor communicatively connected to the processor, the optical sensor reading visual input for the apparatus;
an optical illuminator communicatively connected to the processor, the optical illuminator illuminating for the optical sensor;
an audio output device communicatively connected to the processor, the audio output device providing output at the apparatus location;
an audio input sensor communicatively connected to the processor, sensing audio input to the apparatus;
a non-transitory storage medium communicatively connected to the processor, the non-transitory storage medium comprising:
an alert module, the alert module activating when input is received from an input sensor;
a send module, the send module sending to a user operator, a text message, the text message notifying of an arriving parcel;
a receive module, the receive module receiving a received text message from the user operator; and
an output module, the output module outputting a message based on the text message from the user operator.

2. The parcel delivery verification apparatus of claim 1, wherein the non-transitory storage medium further comprises a voice-to-text module, wherein the voice-to-text module reads input from the audio input sensor to create a text message based on the input.

3. The parcel delivery notification apparatus of claim 2, wherein the non-transitory storage medium further comprises a text-to-voice module, wherein the text-to-voice module causes the audio output device to emit word sounds based on the received text message.

4. The parcel delivery notification apparatus of claim 3, wherein the non-transitory storage medium further comprises a language translation module, the language translation module translating the text message from a first language to a second language.

5. The parcel delivery notification apparatus of claim 1, wherein the non-transitory storage medium further comprises a drone sensing module, the drone sensing module detecting the presence of a parcel delivery drone using the audio input sensor.

6. The parcel delivery notification apparatus of claim 1, wherein the non-transitory storage medium further comprises a drone sensing module, the drone sensing module detecting the presence of a parcel delivery drone using the optical sensor.

7. The parcel delivery notification apparatus of claim 1, wherein the non-transitory storage medium further comprises a greeting module, the greeting module using the audio output device to initiate a greeting.

8. The parcel delivery notification apparatus of claim 1, wherein the send module further comprises sending an image produced by the optical sensor.

9. The parcel delivery notification apparatus of claim 8, wherein the send module further comprises illuminating an area using the optical illuminator to enhance the image produced by the optical sensor.

10. The parcel delivery notification apparatus of claim 1, wherein the non-transitory storage medium further comprises an illumination module, the illumination module illuminating a location to place a parcel.

11. A method for verifying the delivery of a parcel using a parcel delivery notification apparatus, the method comprising:
activating a parcel delivery apparatus when input is received from an input sensor;
sending to a user operator, a text message, the text message notifying the user operator of the arrival of a parcel;
receiving a received text message from the user operator; and
outputting a message based on the text message from the user.

12. The method of claim 11, further comprising reading, from an audio input sensor, audio input.

13. The method of claim 12, further comprising emitting word sounds based on the received text message.

14. The method of claim 13, further comprising translating, from a first language to a second language, the text message.

15. The method of claim 11, further comprising detecting, via the audio input sensor, a parcel delivery drone.

16. The method of claim 11, further comprising detecting, via an optical sensor, a parcel delivery drone.

17. The method of claim 11, further comprising greeting, via an audio output device, a parcel deliverer.

18. The method of claim 11, further comprising sending an image produced by an optical sensor.

19. The method of claim 18, further comprising illuminating an area using the optical illuminator to enhance the image produced by the optical sensor.
